(19) United States
(12) Patent Application Publication
(10) Pub. No.: US 2012/0095846 A1
(43) Pub. Date: Apr. 19, 2012

(54) Systems and methods for providing social networking, wherein a user can create multiple profiles within a single account

(76) Inventor: Derek John Leverant, Greenville, SC (US)

(21) Appl. No.: 13/272,325

(22) Filed: Oct. 13, 2011

Related U.S. Application Data
(60) Provisional application No. 61/404,989, filed on Oct. 13, 2010.

(51) Int. Cl. G06Q 30/02; G06F 17/30

(52) U.S. Cl. 705/14.73; 707/803; 707/821; 707/706; 707/E17.005; 707/E17.01; 707/E17.108

(57) ABSTRACT

The present invention relates to systems and methods for providing social networking. A social-networking system in accordance with the present invention enables users to create multiple profiles within a single account. The social-networking system typically includes a database for storing a plurality of user accounts. The social-networking system also typically includes an interface for receiving material to be stored on the database and transmitting material stored on the database. Each user account includes one or more user profiles. Within the social networking system, users can establish relationships with one another.

### CROSS-REFERENCE TO PRIORITY APPLICATION

This application hereby claims the benefit of U.S. Patent Application No. 61/404,989 for Systems and methods for providing a social networking system, wherein a user can create multiple profiles within a single account (filed Oct. 13, 2010), which is hereby incorporated by reference in its entirety.

### FIELD OF THE INVENTION

The present invention relates to social-networking systems and methods for sharing user-generated content.

### BACKGROUND

Networks for building social relationships and sharing user-generated content have become among the most widely used web sites on the globe. These social networks allow users to generate a profile, which is a web page that allows a user to display information (e.g., personal information) about themselves. Furthermore, the profile may allow users to display pictures, videos, and blog entries. The profile is typically saved on a social-networking server so it can be shared among other users.

Prior social-networking systems include Facebook, Myspace, Linkedin, and Friendster. Within these social-networking systems, a first user typically generates a profile and then establishes a relationship with other users who have created a profile. The first user may then share user content with users that have established a relationship with the first user. Users with whom the first user has established a relationship with are often referred to as friends.

One problem associated with prior social-networking systems is that a user is typically required to share the same material with all the users with whom the user has established a relationship (e.g., friendship). For example, material that is intended to be shared only with close family members can also be viewed by business associates or friends.

Prior social-networking systems have sought to cure this problem through a system commonly referred to as grouping. Within various social-networking systems, grouping may be referred to as creating groups or lists. Grouping allows users to create smaller circles of connections within their user profile. Personal information can then be exclusively shared within such a smaller circle of connections (e.g., group). These circles of connections can be arranged according to their relationship with the user.

That said, basic material in a user's profile (e.g., the user's list of friends, the user's basic personal information, groups the user is involved in, and pictures posted on the user's profile) is shared with all other users with whom that user has established a relationship. In other words, the process of grouping only allows for the privacy of additional material; grouping does not restrict access to a user profile itself.

Accordingly, a need exists for an improved social-networking system.

### SUMMARY

Accordingly, in one aspect, the present invention embraces a method of establishing a social network. The method includes creating a database and storing the database on a non-transitory computer-readable medium. A first user account is created in the database. The first user account includes material about a first user. A first user profile and a second user profile are created in the first user account. A second user account, which includes material about a second user, is also created in the database.

A relationship is established between the first user account and the second user account. This relationship gives the second user access to one or more of the first user's profiles. For example, the relationship may give the second user access to the first user's first user profile but not give the second user access to the first user's second user profile. Similarly, this relationship gives the first user access to one or more profiles created in the second user account.

In another aspect, the present invention embraces a social-networking system that enables users to create multiple profiles within a single account. The social-networking system typically includes a non-transitory computer-readable storage medium and a processor for manipulating the computer-readable storage medium. A database is stored on the computer-readable storage medium. The social-networking system typically includes an interface for receiving material to be stored on the database and transmitting material stored on the database. The database typically includes at least a first user account and a second user account. The first user account typically includes a first user profile and a second user profile. The second user account typically includes one or more user profiles. Typically, the first user account and the second user account have an established relationship.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 depicts a graphical user interface displaying an exemplary account login page, where a user can login to their existing account or create a new account.

FIG. 2 depicts a graphical user interface having an open overlay and displaying a user's home page.

FIG. 3 depicts a graphical user interface displaying a user profile page as seen by that user.

FIG. 4 depicts a graphical user interface displaying a user profile page as seen by other users.

FIG. 5 depicts a GUI displaying a business profile page.

### DETAILED DESCRIPTION

In one aspect, the present invention embraces a social-networking system that enables users to create multiple profiles within a single account.

The social-networking system includes a computer-readable storage medium (e.g., non-transitory computer-readable storage medium) in communication with a processor (e.g., a microprocessor). The processor can execute commands stored on the computer-readable storage medium. Moreover, the processor can manipulate data stored on the computer-readable storage medium. The computer-readable storage medium and the processor may be located within one or more servers (e.g., a social-networking server).

The social-networking system includes a database for storing user material. Typically, the database is stored on the computer-readable storage medium (e.g., in a social-networking server).

The social-networking system typically includes an interface in communication with the database that allows users to access the social-networking system. The interface enables users to connect to the social-networking system via a network, such as the World Wide Web. For example, users may connect to the social-networking system via an electronic device (e.g., a computer, smart phone, or tablet) that is connected to the internet (e.g., through a web browser). The interface may provide users with a graphical user interface (GUI). The GUI may (i) display material from the social-networking system to a user and (ii) enable a user to interact with the social-networking system (e.g., download or upload content).

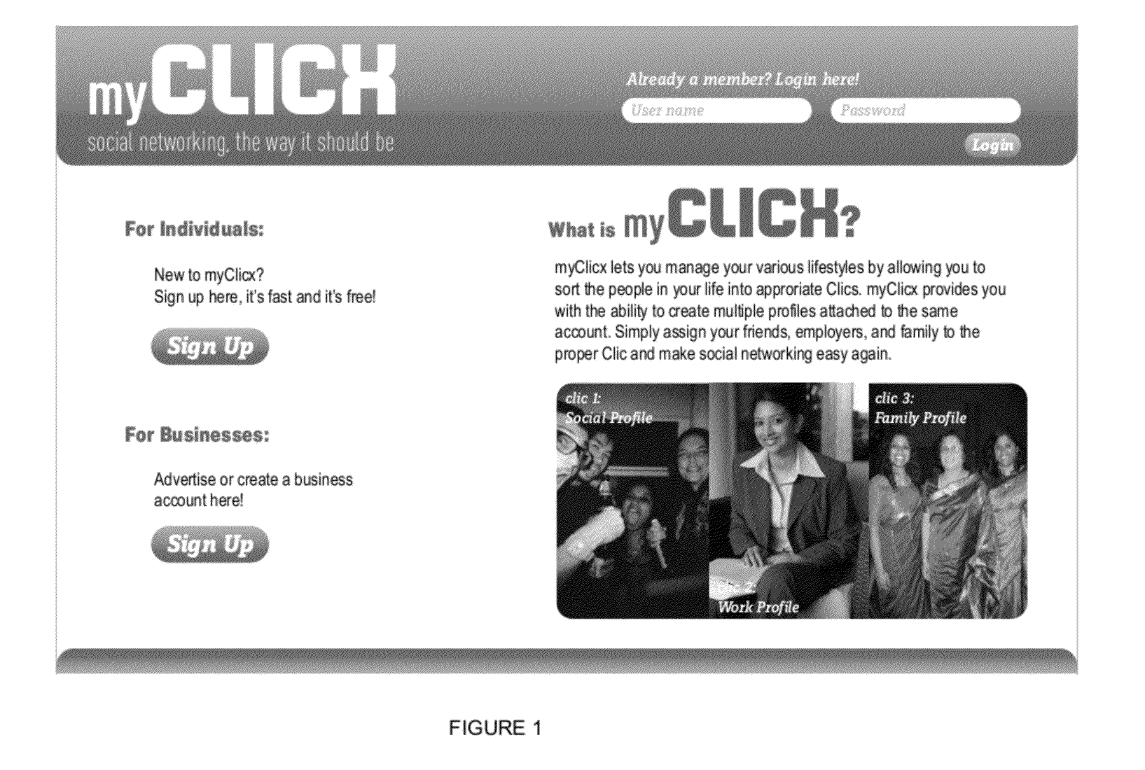

Once a user accesses the social-networking system (e.g., via the World Wide Web), the user (i) may login to an existing account (e.g., by entering a username and password) or (ii) may create a new account. In this regard, FIG. 1 depicts the GUI displaying an exemplary account login page, where a user can login to their existing account or create a new user account. Material relating to each user account is typically stored in the database.

Once a user account has been created, it is stored in the database. In addition, once a user creates an account, the user may create a user profile. The user may include material within the user profile. For example, the user may include personal information such as the user's name, birthday, contact information, career information (e.g., current and past employers), educational background, interests, and/or hobbies. What is more, the user may upload content (e.g., photographs, videos, music, and/or journal entries) to their user profile. In addition, the user may include status updates and other comments in their profile. Typically, users can post comments related to uploaded content (e.g., photographs, videos, and/or journal entries) or to prior status updates. This material relating to the user profile is typically stored in the database.

Once a user has created a first user profile, the user then has the option of creating one or more additional profiles connected to the same user account. Each created profile may have a name and function designated by the user. In this regard, the user may determine what material (e.g., information and/or content) to include in each profile. In other words, particular material may be included in one user profile, but not in others. For example, a user may create a work profile, which may include material particularly relevant to the user's occupation. In addition, the user may create a social profile, which may include material particularly relevant to the user's social life. For example, the user may upload content (e.g., photographs) to the social profile that may not be appropriate for inclusion in the user's work profile.

Once a user has created a user account and one or more user profiles, the user may establish relationships (e.g., connections) with other users. In this regard, users with whom a first user has established a relationship may be known as the first user's friends. For example, the interface may provide users with a search engine connected to the database that allows a user to search for other users. Various types of information can be used to search for other users including: user name, location (e.g., current city of residence), educational background, employer, interests, and/or hobbies.

Typically, once a first user locates a second user with whom the first user wishes to establish a relationship, the first user will send a relationship request (e.g., friend request) to the second user (e.g., via the interface). The second user typically will then have the option of accepting or denying the relationship request. Once the second user accepts the relationship request (e.g., via the interface), the relationship is established and stored in the database. Typically, the first user will receive no notice of the denial of the relationship request by the second user.

Once the second user accepts the relationship request, the interface typically prompts the second user to place the first user in one of the second user's user profiles. The second user then selects which profile to place the first user in (e.g., according to the actual form of relationship between the first user and the second user). That said, the second user may place the first user in any profile, regardless of their actual relationship. In one embodiment, the second user may add the first user to more than one profile.

Similarly, once the second user accepts the relationship request, the interface typically prompts the first user to place the second user in one of the first user's user profiles. The first user then selects which profile to place the second user in.

After the first user has been placed in one of the second user's profiles, the first user will be able to access material, such as information (e.g., personal information) and/or content (e.g., photographs and/or videos), contained within that profile (e.g., via the interface). Similarly, after the second user has been placed in one of the first user's profiles, the second user will be able to access material contained within that profile.

Users are typically unable to access profiles to which they have not been added. For example, if the first user adds the second user to his work profile but not to his social profile, the second user will be able to access material in the first user's work profile but will not be able to access material found only in the first user's social profile. Typically, neither the first user nor the second user will have access to one of the other's profiles until both the first user and the second user have placed the other in a profile. By only allowing users to access user profiles to which they have been added, the present social-networking system provides improved privacy as compared with prior social-networking systems.

In one embodiment, users may have the option of designating one of their profiles as their default profile. In this regard, the interface may prompt a user to designate one of the user's profiles as a default profile. In a particular embodiment, the first profile created by a user is designated as the default profile until the user designates another profile as the user's default profile.

A first user's default profile is typically viewable by other users, even if those other users have not established a relationship with the first user. The material in the default profile that can be viewed by users that have not established a relationship with the first user is typically limited. For example, the social-networking system may automatically restrict access to material in the default profile. By way of further example, users that have not established a relationship with the first user may be able to view basic personal information but may not be able to view a list (e.g., friend list) of users with whom the first user has established a relationship. In one embodiment, the first user may have the option of restricting what material in the default profile can be accessed by users with whom the first user does not have a relationship.

Moreover, the first user's default profile is typically viewable by all users with whom the first user has (i) established a relationship and (ii) placed in more than one profile, even if such users have not been placed within the first user's default profile. Accordingly, if a second user is placed in only one of the first user's profiles and that profile is not the first user's default profile, the second user typically will not have access to the first user's default profile. Of course, if a second user is only placed within the first user's default profile, the second user will only have access to the first user's default profile.

The social-networking system typically includes a messaging system that allows users to exchange messages. For example, the messaging system may enable users to exchange electronic mail or instant messages. In one embodiment, messages may only be exchanged between users that have an established relationship.

In a particular embodiment, the social-networking system may include groups in which a first user may invite users with whom the first user already has an established relationship to form a higher degree of relationship. In this regard, the first user may create one or more groups within one or more of the first user's profiles. The first user may then request that one or more other users within the relevant profile join the group. Once the other users have confirmed that they wish to join the group, the first user may then share material (e.g., messages, photographs, and/or videos) privately with all of the members of the group.

In yet another embodiment, the GUI provided to users via the interface may include an open overlay. Accordingly, the GUI may display all of a user's profiles to that user (e.g., displayed within a home page). Indeed, an open overlay typically enables a user to navigate to all of the user's profile pages (e.g., via a pop-up box) without having to navigate to another website. Moreover, each user profile displayed within the home page is typically live, such that new material (e.g., comments from other users) are automatically displayed (e.g., in real time).

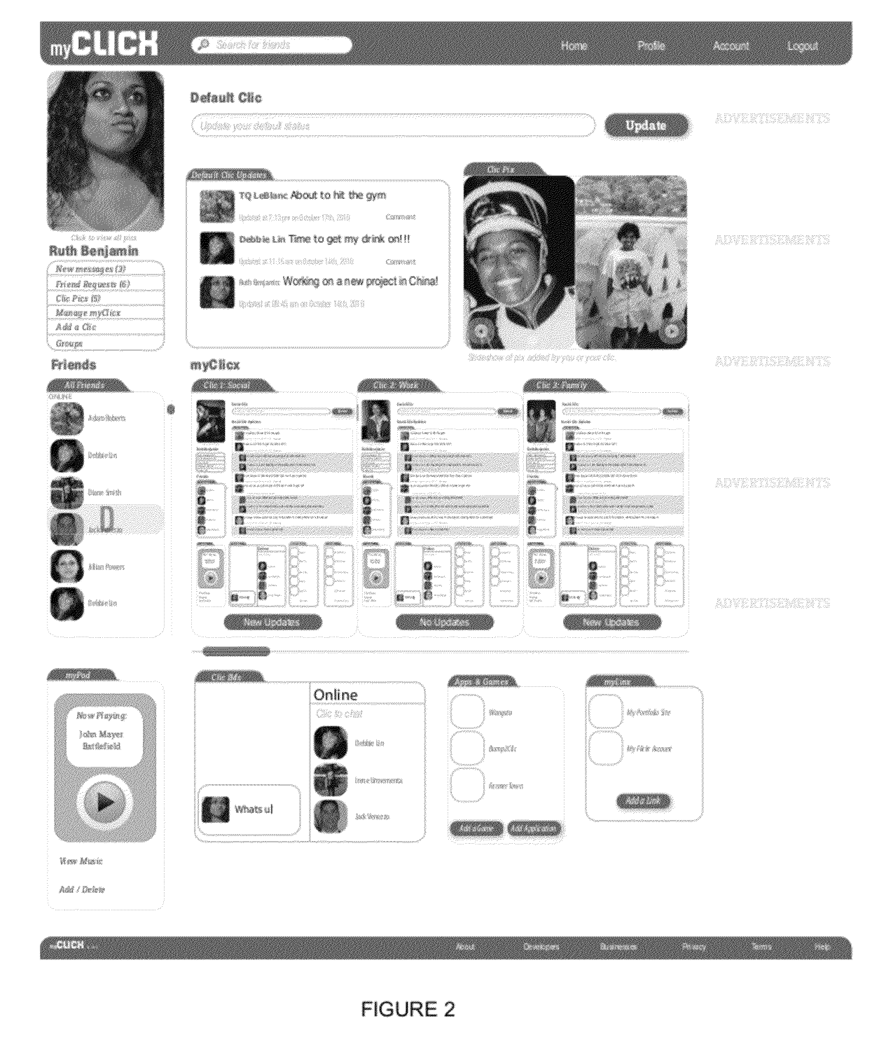

In this regard, FIG. 2 depicts a graphical user interface having an open overlay and displaying a user's home page. The user is typically directed to the home page after signing in to the user's account. Within the home page, the user can view all of the user's profiles, including the user's default profile, associated with the user's account. In one embodiment, the default profile is integrated into the home page. Accordingly, there may not be a default profile page that is distinct from the home page.

In addition and within the home page, the user can upload content (e.g., photographs and/or videos) to the user's account. Once the user has uploaded content, the interface will typically prompt the user to select one or more user profiles to place the uploaded content in.

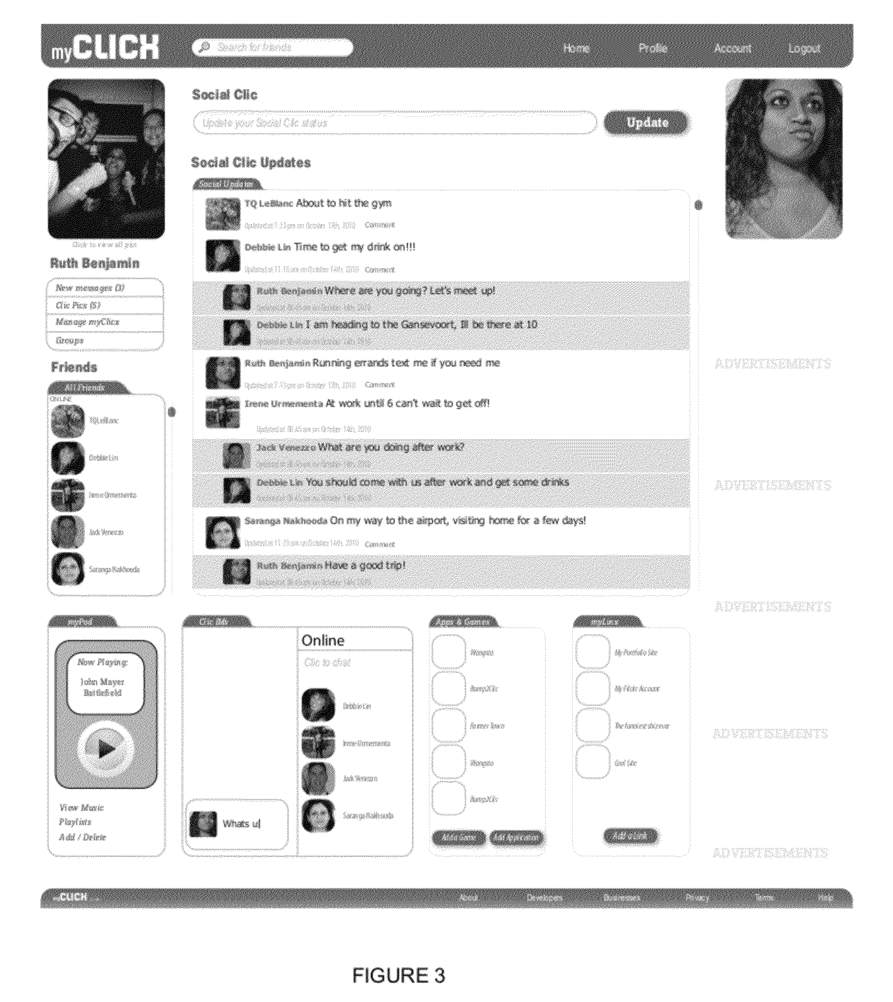

From the home page, the user can select and then be directed to one of the user's particular user profiles. FIG. 3 depicts a GUI displaying a user profile page, in particular a user's social profile (e.g., social clic), as seen by the user. Once the user has navigated to a particular user profile, the user can upload information (e.g., personal information), provide status updates, and make comments specific to that user profile. In addition, the user can send messages to users that have been assigned to that particular profile. For example, if a first user wanted to send a message to a second user that has only been assigned to the first user's social profile, the first user would have to navigate to the social profile before sending a message to the second user or reading a message from the second user.

In a particular embodiment that enhances privacy, the user can only upload information, provide status updates, make comments to a particular profile and send messages to users assigned to that particular profile after navigating to that particular profile. That said, content (e.g., photographs and/or videos) may still be uploaded from the user's home page. In addition, the user typically can upload material to the default profile from the user's home page.

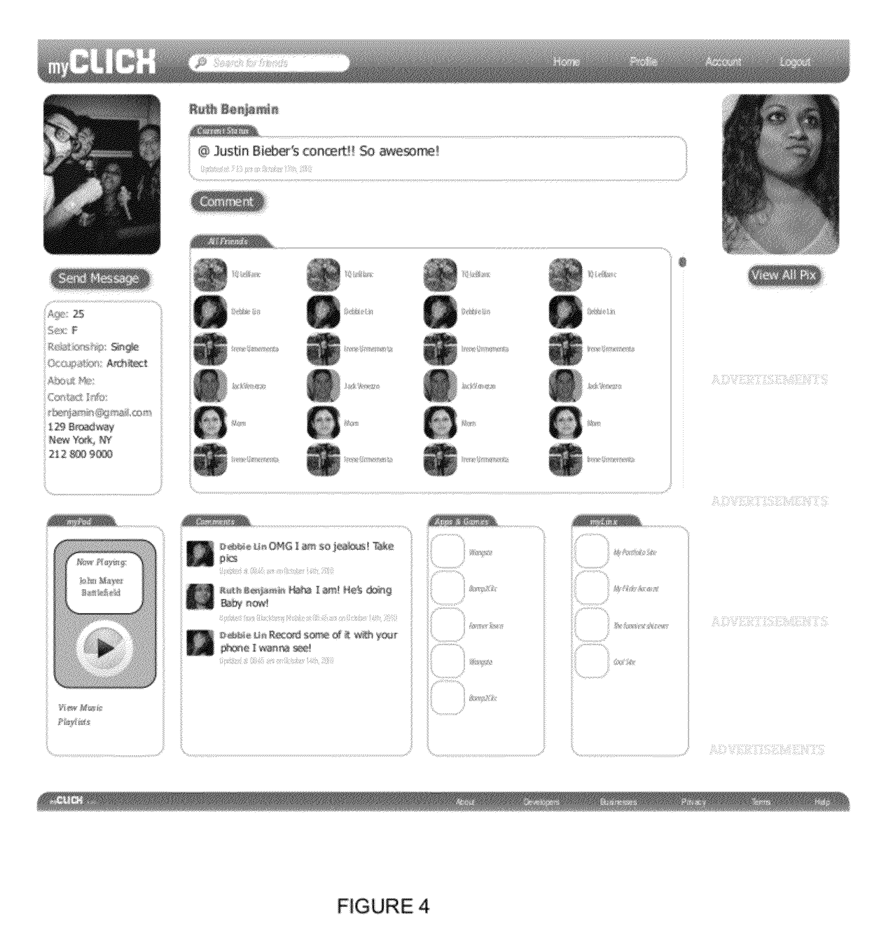

FIG. 4 depicts a GUI displaying a first user's user profile page as seen by other users. From the first user's profile page, a second user typically can access all material from the first user's profiles to which the second user has been added. For example, if the second user has been added to the first user's work profile and social profile, the first user's profile page, as displayed to the second user, will typically include material from the first user's work profile and social profile.

From the first user's profile page, other users typically can send messages to the first user and post comments (e.g., comments regarding content on the first user's profile page). In one embodiment, other users can post content (e.g., photographs and videos) on the first user's profile page.

Other users can also typically view in the first user's profile page a list of users (e.g., a friend list) with which the first user has established a relationship and placed within that particular profile. In other words, users placed only in other user profiles are typically not included in the list of users (e.g., friend list). By way of example, if a second user has been added to (e.g., placed within) a first user's work profile and default profile, the second user will be able to view a list of users that have been added to the first user's work profile or to the first user's default profile. By way of further example, if the second user has only been added to the first user's work profile, the second user will only be able to view a list of users that have been added to the first user's work profile.

As depicted in FIGS. 2-4, the GUI typically includes a search toolbar connected to the social-networking system's search engine. This search toolbar enables a user to search for other users. Once a user finds another user with whom they wish to establish a relationship, the user can request the establishment of a relationship from the GUI (e.g., by pressing an “add as a friend” button).

The social-networking system may include applications (e.g., games) that users can access from their home page. Information relating to applications may be shared with other users.

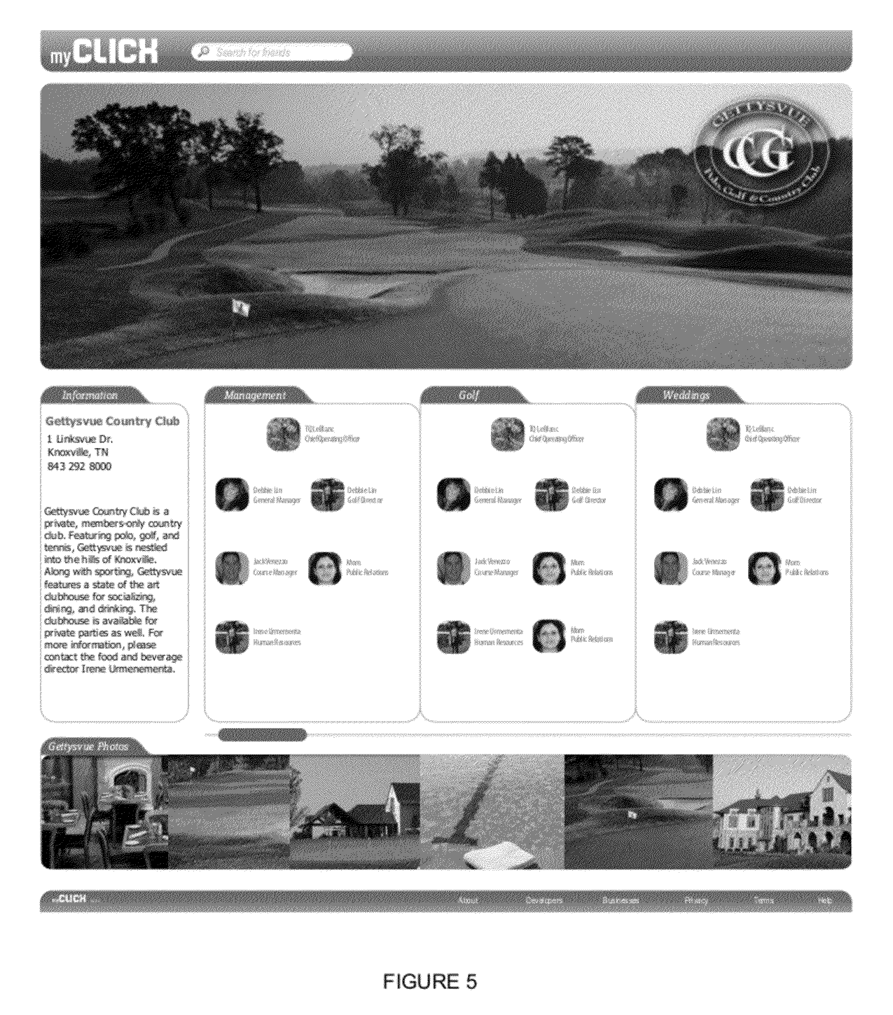

In one embodiment, the social-networking system may allow businesses to create a business account and corresponding business profile. FIG. 5 depicts a GUI displaying a business profile page. Within the business profile, the business may include relevant material such as the name of the business, location, hours of operation, contact information, an overview of the business, different departments within the business, employee information, photographs, and/or videos. In a particular embodiment, users may be able to communicate directly via the interface (e.g., using electronic mail or instant messaging) with businesses that have a business account and corresponding business profile.

The social-networking system may include advertisements. The advertisements are typically visible to users within the GUI provided by the interface. The advertisements are typically linked to a business profile, such that when a user clicks on an advertisement, the user is then directed to the linked business profile within the GUI. Typically, the advertisements do not direct users to a website outside of the social-networking system, thereby facilitating user privacy.

To supplement the present disclosure, this application incorporates entirely by reference the following patents: U.S. Pat. No. 8,005,896; U.S. Pat. No. 7,996,468; U.S. Pat. No. 7,890,581; U.S. Pat. No. 7,885,986; U.S. Pat. No. 7,792,903; U.S. Pat. No. 7,765,257; U.S. Pat. No. 7,752,553; U.S. Pat. No. 7,752,552; and U.S. Pat. No. 7,743,100.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method of establishing a social network, comprising:
creating a database and storing the database on a non-transitory computer-readable medium;
creating a first user account in the database, the first user account including material about a first user;
creating a first user profile in the first user account; and
creating a second user profile in the first user account.

2. A method according to claim 1, comprising:
creating a second user account in the database, the second user account including material about a second user; and
establishing a relationship between the first user account and the second user account.

3. A method according to claim 2, wherein the relationship (i) gives the second user access to the first user's first user profile but (ii) does not give the second user access to the first user's second user profile.

4. A method according to claim 2, wherein the step of establishing a relationship between the first user account and the second user account, comprises:
receiving a request from the first user to establish a relationship with the second user;
sending the request to the second user; and
receiving an acceptance of the relationship request from the second user.

5. A method according to claim 4, wherein the step of establishing a relationship between the first user account and the second user account, further comprises:
prompting the first user to place the second user in one or more of the first user's profiles;
receiving a request from the first user to place the second user in at least one of the first user's profiles; and
placing the second user in at least one of the first user's profiles.

6. A method according to claim 5, comprising:
creating one or more user profiles in the second user account;
wherein the step of establishing a relationship between the first user account and the second user account, further comprises: (i) prompting the second user to place the first user in one or more of the second user's profiles, (ii) receiving a request from the second user to place the first user in at least one of the second user's profiles, and (iii) placing the first user in at least one of the second user's profiles.

7. A method according to claim 2, comprising designating one of the first user's user profiles as a default profile.

8. A method according to claim 7, wherein the step of designating one of the first user's user profiles as a default profile comprises automatically designating the first user's first user profile as a default profile.

9. A method according to claim 7, wherein the step of designating one of the first user's user profiles as a default profile comprises:
receiving a request from the first user to designate the first user's first user profile as a default profile; and
designating the first user's first user profile as a default profile.

10. A method according to claim 2, comprising
designating the first user's first user profile as a default profile; and
giving access to the first user's first user profile to a third user having a third user account, wherein the third user account does not have an established relationship with the first user account.

11. A method according to claim 2, comprising:
creating a third user profile in the first user account;
designating the first user's first user profile as a default profile; and
giving access to the first user's first user profile to the second user if (i) the second user has been placed in the first user's first user profile and/or (ii) the second user has been placed in the first user's second user profile and in the first user's third user profile.

12. A method according to claim 2, comprising:
creating a third user account in the database, the third user account including material about a third user;
establishing a relationship between the first user account and the third user account;
receiving a request from the first user to place the second user and the third user in a group;
placing the second user and the third user in the group; and
privately sharing material provided by the first user with the second user and the third user.

13. A social-networking system, comprising:
a non-transitory computer-readable storage medium;
a processor for manipulating said computer-readable storage medium;
a database being stored on said computer-readable storage medium, said database including a first user account and a second user account, said first user account including material about a first user, and said second user including material about a second user; and
an interface for receiving material to be stored on said database and transmitting material stored on said database;
wherein said first user account includes a first user profile and a second user profile;
wherein said second user account includes one or more user profiles; and
wherein said first user account and said second user account have an established relationship.

14. A social-networking system according to claim 13, wherein said first user account and said second user account have an established relationship such that said interface (i) provides the second user access to said first user account's first user profile but (ii) does not provide the second user access to said first user account's second user profile.

15. A social-networking system according to claim 13, wherein said interface provides a graphical user interface that enables the first user and/or the second user to view material stored on said database and interact with the social-networking system.

16. A social-networking system according to claim 15, wherein said graphical user interface has an open overlay.

17. A social-networking system according to claim 15, wherein said graphical user interface displays one or more advertisements.

18. A social-networking system according to claim 17, comprising a business account stored in said database, said business account having a business profile page that includes material about a business.

19. A social-networking system according to claim 18, wherein said graphical user interface displays said business profile page to the second user after the second user clicks on an advertisement linked to said business profile page.

20. A social-networking system according to claim 15, wherein said graphical user interface includes a search toolbar connected to a search engine that enables the first user and/or the second user to search for other users.
